(19) United States
(12) Patent Application Publication
(10) Pub. No.: US 2012/0291802 A1
(43) Pub. Date: Nov. 22, 2012

(54) MULTI-USE CLEANING AND CONDITIONING CLOTH

(76) Inventors: Lei Zhu, Bedford, MA (US); Chunlei Huang, Bedford, MA (US)

(21) Appl. No.: 13/486,090

(22) Filed: Jun. 1, 2012

Related U.S. Application Data
(63) Continuation-in-part of application No. 12/959,617, filed on Dec. 3, 2010.
Application No. 12/959,617 is a continuation-in-part of application No. 12/647,248, filed on Dec. 24, 2009.

(51) Int. Cl. A47K 7/02; B08B 1/00; B31B 13/00

(52) U.S. Cl. 134/6; 15/209.1; 493/374

(57) ABSTRACT

A multi-use cloth for cleaning and conditioning metal and non-metal objects includes a two-layer, three-layer or multi-layer structure. Each layer is made of material either capable of retaining an oil, aqueous solution, aqueous suspension or solid or capable of preventing penetration of an oil, aqueous solution, aqueous suspension or solid. In a three-layer or multi-layer cloth, the separation layer is affixed in between two layers having one or both layers embedded with an oil, aqueous solution, or aqueous suspension. In a two-layer cloth, the separation layer is affixed to one side of the layer that is embedded with an oil, aqueous solution or an aqueous suspension. The cloth is folded with the oil, or aqueous solution, or aqueous suspension embedded side on an inner side. A user's hand holds the outside of the cloth and no contamination from oil, aqueous solution, or aqueous suspension or solid occurs.

This Continuation-in-Part application claims the benefit of U.S. patent application Ser. No. 12/959,617, filed Dec. 3, 2010 which is a Continuation-in-Part of U.S. patent application Ser. No. 12/647,248, filed Dec. 24, 2009, both of which are incorporated herein by reference.

### BACKGROUND OF THE INVENTION

1. Field of the Invention

The present device and method relates to the field of the cleaning and conditioning of various metal objects, including but not limited to ice skates, hockey skates and speed skates, ski edges, snow board edges, sled runners, knives, and fishing rods. It also relates to the field of the cleaning and conditioning of various non-metal objects, including but not limited to human and animal skin, wood, stone, glass and leather. This present device and method is more specifically applicable to maintenance of the objects by cleaning and drying the various objects subsequent to use, and conditioning them by applying oil or wax, thereby preventing corrosion of the metal.

2. Description of the Related Art

The device and method were first applied to ice skate blades, which become wet when used, and whereby the blades may corrode if not immediately dried after use. The cloth of the present device and method is of a non-abrasive type, so that the sharp edge of the blade is not dulled by drying and conditioning.

Other metal objects have similar characteristics and benefit in the same as do ice skate blades. These other metal objects include ski edges, snow board edges, sled runners, knives, fishing rods, guns and golf clubs. Although fishing rods do not have sharp edges as to the other objects listed above, they also benefit from the application of oil or wax with the present device, since corrosion is inhibited thereby.

A typical ice skate is shown in FIG. 1, the skate comprising a body 1 and blade 3. The blades are generally various varieties of stainless steel, or other types of corrosion resistant steels, although other materials, such as aluminum and titanium, also exist in the prior art. Nevertheless, many of the blade materials used in the manufacture of ice skates are generally subject to corrosion.

During skating, both pressure and friction between the skate blades and the ice create the water lubricant required for skating. In addition, the ice is scraped into a slush or “snow” by the ice skate blades as a result of the various maneuvers common to ice skating. In particular the techniques used in stopping invariably create such “snow”, which accumulates on the blades. If left on the blades, the “snow” results in some corrosion, which dulls the blades, among other problems. The general solution to such corrosion has been to sharpen the blades when corrosion occurs. This can be both expensive and time consuming.

One solution to the accumulation of water on the skate blades has been to use “soakers” on the skate blades after use. FIG. 2 shows an example of a “soaker”, fitted about the blade of a skate. These are generally made of a soft, absorbent fabric, such as terry cloth. They are generally kept on the skate blades when the blades are not in use.

It has been found that the use of “soakers” does not completely prevent the development of corrosion on the surface of the skate blades as water, dust and rust accumulate inside the soaker overtime.

Another solution is to wipe off snow by a towel. However, a towel may become wet, dirty and/or impregnated with rust. A wet, dirty and rusty towel may cause more damage to the blades.

One method found to be effective for preventing corrosion is the application of oil on the skate blade. Various types of oil, including anti rust, anti corrosion, natural and synthetic, can be used, as well as vegetable oil of the type used for cooking. However, applying oil from an oil can has been found to be awkward and messy. The best protection requires applying oil immediate after each skating event when skates are not in use. Carrying an oil can or container is not convenient. Furthermore, it has been found that applying oil from an oil can or vegetable oil bottle onto the surface of the skate blades has resulted in a substantial amount of waste in the application, especially since the most effective placement of the oil is on the edges of the blade, where accumulation of corrosion is the most troubling. Additives such as chemicals and juices can also be added to oil to form solutions or suspensions for better effect of rust inhibition or more friendly smell. Chemicals can include volatile amines and benzotriazole. Juices can include plant extracts and essential oils such as citrus extract and rose oil. Oil can be combined or replaced by wax such as Carnauba wax and Monton wax for the same rust prevention effect.

The present device and method provides a simple, clean, inexpensive, and environment friendly way of applying the oil, reducing the amount of waste and eliminating oil on the hands of the user.

When the present device and method is applied to the use for non-metal objects, oil may be replaced by solutions and suspensions using other solvents such as water and or alcohol. Oil can also be replaced by solids and solid powders such as mineral powder.

The present device and method also presents a general application to the field of the cleaning and conditioning of various metal and non-metal objects. It is convenient and safe to the user, friendly to environment and effective to waste reduction.

### SUMMARY OF THE INVENTION

It is an objective of the present device and method to provide a device and means for preventing corrosion on the blades of ice skates and other metal objects.

In accordance with one aspect of the device and method, a cleaning and conditioning cloth includes a body of cut-resistant, water-absorbent fabric, and a piece of oil-impregnated fabric, affixed to the approximate center of the body.

In accordance with a second aspect of the device and method the piece of oil-impregnated fabric may be removably affixed to the center of the rectangular body, and may have a square, rectangular, circular, or other shape.

In accordance with a third aspect of the device and method the oil used is anti-rust, anti-corrosion, natural or synthetic, semi-synthetic oil, wax, or vegetable oil.

In accordance with a fourth aspect of the device and method the piece of oil-impregnated fabric is square, circular, diamond-shaped, or having other shapes.

In accordance with a fifth aspect of the device and method, the cleaning and conditioning cloth is used by the steps of holding it in one hand and the ice skate in the other, placing the blade of the ice skate in the middle of the oil impregnated fabric, and moving the ice skate and the cleaning and conditioning cloth relative to each other.

In accordance with a sixth aspect of the device and method the blade moves from the cleaning and conditioning cloth body to the oil impregnated fabric.

In accordance with a seventh aspect of the device and method, the user moves the blade away from the cleaning and conditioning cloth body after it passes through the oil-permeated fabric.

In accordance to an eighth aspect of the device and method, the user can apply oil to the skate blade by other methods, such as but not limited to a brush, spread and sponge.

In accordance to a ninth aspect of the device and method, the oil-impregnated fabric can be used in combination with a water absorbent fabric without impregnated oil for better results.

In accordance to a tenth aspect of the device and method, the whole device can be made from recycled materials and collected after use for reprocess and then reuse.

In accordance with an eleventh aspect of the device and method the cleaning and conditioning cloth includes a first layer comprising a cut-resistant, non-abrasive, low lint, water-absorbent and oil-absorbent material, a second layer comprising oil-embedded material; and a third layer, disposed between the first and second layers, comprised of a material that prevents contamination between the first and second layers.

In accordance with a twelfth aspect of the device and method the third layer is affixed on one surface to the first layer, and on an opposite surface to the second layer, forming a single cloth thereby.

In accordance with a thirteenth aspect of the device and method cleaning any one of the members of a group which consists of ice skate blades, ski edges, snow board edges, sled runners, knives, fishing rods, guns and golf clubs.

In accordance with a fourteenth aspect of the device and method the oil sheet can be same size as body of the other layers.

In accordance with a fifteenth aspect of the device and method the oil sheet is back coated with other material to prevent the oil from further penetrating through other sheets.

In accordance with a sixteenth aspect of the device and method the material made for each layer of a three-layer cloth can be the same or different.

In accordance with a seventeenth aspect of the device and method the material made for each layer of the three-layer cloth can be nature (such as but not limited to cotton, wood, wool and leather), synthetic (such as but not limited to polymer, plastic and synthetic rubber) or mixture of nature and synthetic and recycled materials.

In accordance with an eighteenth aspect of the device and method the size for each layer of the three-layer cloth can be the same or different.

In accordance with a nineteenth aspect of the device and method the color of each layer of the three layer cloth can be the same or different.

In accordance with a twentieth aspect of the device and method the two outer layers of the three-layer cloth are made of material that is capable to retain oil solution, oil suspension, aqueous solution, aqueous suspension and solids.

In accordance with a twenty-first aspect of the device and method the middle layer of the three-layer cloth is made of material that is capable to prevent penetration of oil solution, oil suspension, aqueous solution, aqueous suspension and solids.

In accordance with a twenty-second aspect of the device and method the middle layer of the three-layer cloth is made of material that is capable to provide cut resistance and reinforcement of the entire three layer structure.

In accordance with a twenty-third aspect of the device and method the surfaces of the two outer layers of the three-layer cloth can be one smooth, the other rough or both smooth and rough.

In accordance with a twenty-fourth aspect of the device and method the three-layer cloth is affixed together by an adhesive such as glue or by physical or mechanical force with or without heat.

In accordance with a twenty-fifth aspect of the device and method the middle layer of the three-layer cloth can be combined with one of the outer layers to form a two-layer cloth.

In accordance with a twenty-sixth aspect of the device and method the first layer of the two-layer cloth is embedded with oil solution, oil suspension, aqueous solution, aqueous suspension or solids, the second layer is made of a different material that prevents oil solution, oil suspension, aqueous solution, aqueous suspension or solids from penetrating the first layer. A user would hold the second layer thus no contamination from the first layer would occur.

In accordance with a twenty-seventh aspect of the device and method, a multiple-layer cloth can be made by sequential addition of more separation layers and more outer layers.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

Other characteristics of the device and method will become apparent from a description thereof for preventing corrosion on the blades of ice skates and other objects with reference to, but not limited to, embodiments described below; in which

FIG. 1 depicts a perspective view of a prior art ice skate.

FIG. 2 depicts a perspective view of a prior art ice skate with a “soaker” covering the blade.

FIG. 3 depicts a cleaning and conditioning cloth in accordance with the present device and method.

FIG. 4 depicts a perspective view of the cleaning and conditioning cloth of the present device and method in use.

FIG. 5 depicts a top plan view of a prior art ski

FIG. 5A depicts a side elevation view of the ski of FIG. 5.

FIG. 6 depicts an exploded view of a three-layer embodiment of the present device.

FIG. 6A depicts the top layer of the device of FIG. 6.

FIG. 6B depicts the middle layer of the device of FIG. 6.

FIG. 6C depicts the bottom layer of the device of FIG. 6.

FIG. 7 depicts a perspective view of a user cleaning a ski edge using the cloth cleaning device.

FIG. 8 depicts an exploded view of a three-layer embodiment of the present device with a rough outer surface.

FIG. 8A depicts the top layer of the device of FIG. 8.

FIG. 8B depicts the middle layer of the device of FIG. 8.

FIG. 8C depicts the bottom layer of the device of FIG. 8.

FIG. 9 depicts an exploded view of a two-layer embodiment of the present device.

FIG. 9A depicts the top layer of the device of FIG. 9.

FIG. 9B depicts the bottom layer of the device of FIG. 9.

FIG. 10 depicts an exploded view of a two-layer embodiment of the present device with a rough outer surface.

FIG. 10A depicts the top layer of the device of FIG. 10.

FIG. 10B depicts the bottom layer of the device of FIG. 10.

FIG. 11 depicts an exploded view of a three-layer embodiment of the present device with a hand pocket on one outer layer for easy grabbing.

FIG. 11A depicts the top layer of the device of FIG. 11.

FIG. 11B depicts the middle layer of the device of FIG. 11.

FIG. 11C depicts the bottom layer of the device of FIG. 11.

FIG. 12 depicts an exploded view of a five-layer embodiment of the present device.

FIG. 12A depicts the top layer of the device of FIG. 12.

FIG. 12B depicts a first middle layer 6a of the device of FIG. 12.

FIG. 12C depicts a second middle layer 7a of the device of FIG. 12.

FIG. 12D depicts a third middle layer 6b of the device of FIG. 12.

FIG. 12E depicts the bottom layer 7b of the device of FIG. 12.

FIG. 13 depicts the three layer cloth of the present device being folded.

FIG. 13A depicts an exploded view of the three-layer cloth prior to being folded.

FIG. 13B depicts a side view of the three layer cloth of FIG. 13 prior to folding.

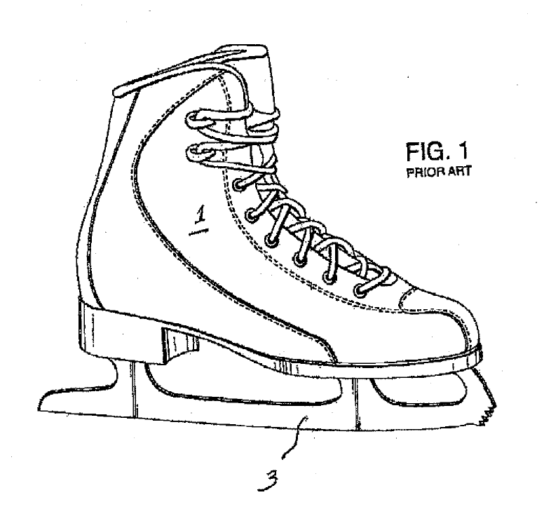

### DESCRIPTION OF THE ILLUSTRATIVE EMBODIMENTS

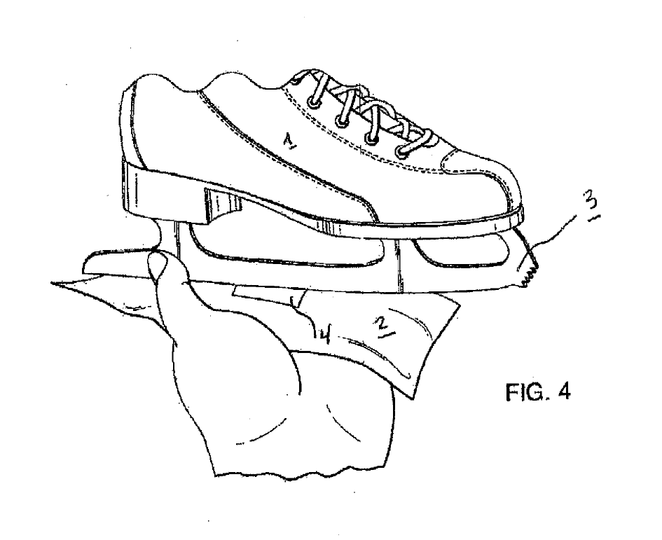

Referring now to FIG. 4, a cleaning and conditioning cloth of the present device and method is shown. The device includes a body 2, which is formed of a sheet of an absorbent material, such as cotton, paper, leather, wool, terry cloth, or any of several synthetic or recycled materials. In particular, a cut-resistant fabric is included in the first embodiment.

Referring to FIG. 4, a user is applying the cleaning and conditioning cloth to a skate blade 3. It may be seen that the front and back of the blade is being wiped by the body 2 of the cleaning and conditioning cloth, while the middle of the blade is in contact with the oil-bearing center portion of the cleaning and conditioning cloth.

An example of such a cut-resistant fiber is made of high tenacity, high modulus polyethylene fiber, available from Ningbo Dacheng Advanced Material Co., Ltd, Zhejiang, China. This material is woven by special high-density knitting machines. Other fabrics may be used. The requirements of this cleaning and conditioning cloth body include (1) the ability to absorb water, and (2) resistance to cutting.

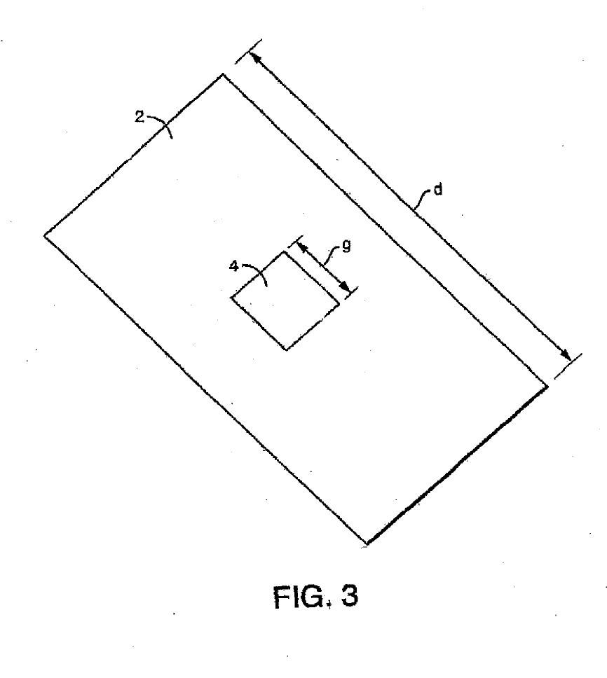

Referring now to FIG. 3, it may be seen that the body 2 of the cleaning and conditioning cloth is rectangular in configuration, approximately between 4 and 18 inches in length d, and between 2 and 12 inches in width. In other embodiments the body may have other shapes. As just described, it is made of a flexible, cut-resistant material with good water-absorption properties.

In the first embodiment the oil square 4, a piece of fabric impregnated with oil, has an approximate width g of 2 inches and a length of 2 inches. This material can be same as or different from the material made of the body 2. The oil square 4 has an adhesive backing so that it will stick to the body 2 of the cleaning and conditioning cloth. In a first embodiment, the oil square is first covered with a layer of contact adhesive on a first side, and then impregnated with oil on the opposite side. The side with the contact adhesive is then adhered to the body of the blade wiper.

In an alternative embodiment if the oil square 4 is made from the same material as body 2, it can simply be part of body 2. In this case, the body 2 is back coated with oil impermeable material, such as plastic sheet, to prevent oil from penetrating to the other side.

In a further embodiment a boundary square, which is a second piece of material having the same dimensions as the oil square, but impermeable to oil, is first permanently affixed to the oil square before the application of any oil. Then contact adhesive is applied to the boundary square, and oil is applied to the oil square. The oil square is finally affixed to the cleaning and conditioning cloth body.

In use, the cleaning and conditioning cloth is held in one hand and the ice skate in the other, as may be seen in FIG. 4. The blade of the ice skate is placed in the middle of the oil square, and the ice skate and or the cleaning and conditioning cloth are moved relative to each other, so that the blade moves from the cleaning and conditioning cloth body to the oil square. In this way the water is first removed from the blade by the cleaning and conditioning cloth body, and then the oil is applied by the oil square. The user lifts the blade away from the cleaning and conditioning cloth as it moves away from the oil square, so that the oil is not removed from the blade once it is applied.

In the first embodiment the cleaning and conditioning cloth is discarded or collected for recycling after each use as the contact adhesive is of a kind which allows the oil square to be peeled off from the cleaning and conditioning cloth body once it is depleted of oil. However, body 2 can be re-used if not dirty or wet. Thus, a user may have a supply of oil squares, already impregnated with oil, to be used with a single, re-usable cleaning and conditioning cloth body.

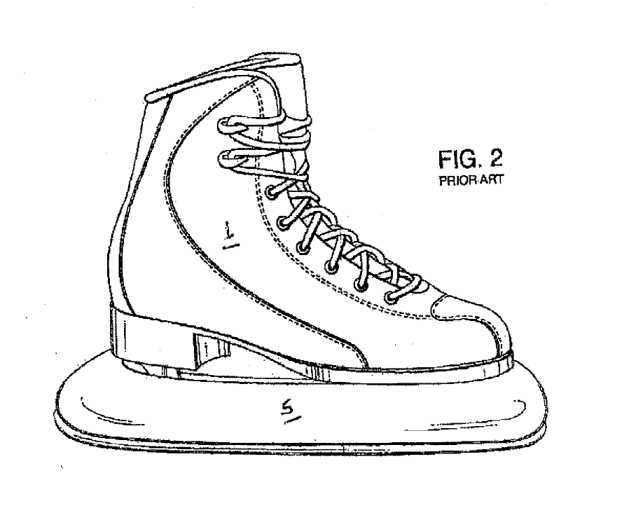

Finally, the ice skate blade may be inserted into a covering similar to the “soaker” shown in FIG. 2, in order to prevent the oil on the ice skate blade from soiling the user's clothing, car seat, etc. This covering should have an outer surface which is impermeable to the oil used in the cleaning and conditioning cloth.

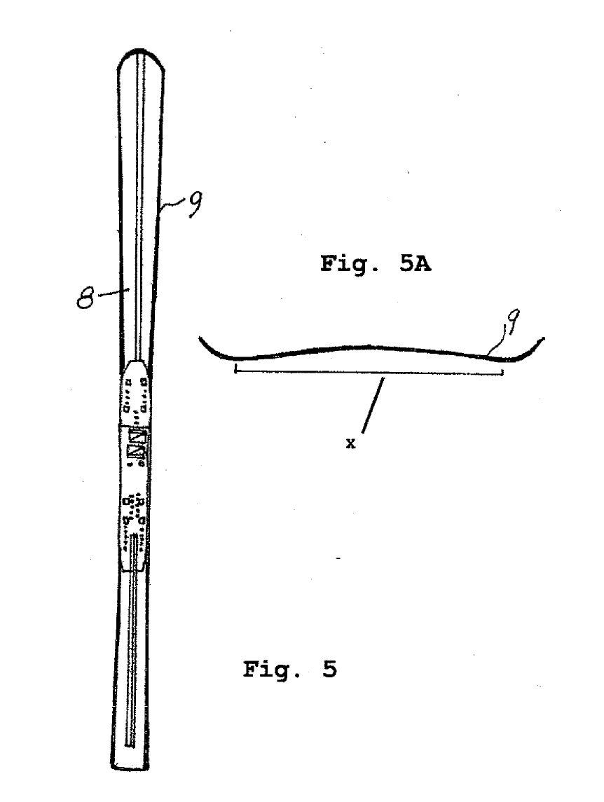

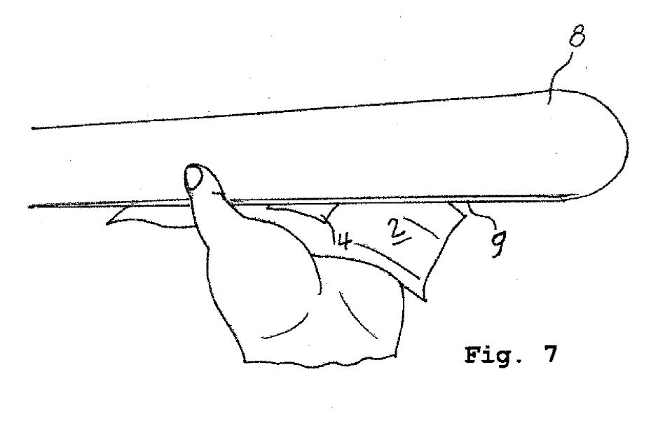

An alternative embodiment may be understood by referring now to FIGS. 5, 5A, and 7. These figures depict a ski 8, and further show the cleaning cloth being used to clean the metallic edges 9 of the ski. The ski edge bears some similarity in that both are made of metal, both are sharp, and both are subject to corrosion. Thus the ski edge 9 should benefit equally from cleaning by the present cleaning cloth, as depicted in FIG. 7. After the ski is removed at the end of the skiing activity, the user places the cloth in the palm of the hand, and wipes the moisture off with the un-oiled portion of the cloth. Then, as shown in FIG. 7, the user wipes the now dried edge of the ski with the oiled or waxed portion 4 of the cloth, thus preserving the metal service against corrosion.

Other objects with sharp metal edges also benefit from cleaning with the cleaning cloth as described herein. These objects include knives, snow boards, and sled runners. Even objects without sharp edges, such as fishing rods, guns and golf clubs, benefit from cleaning with this device.

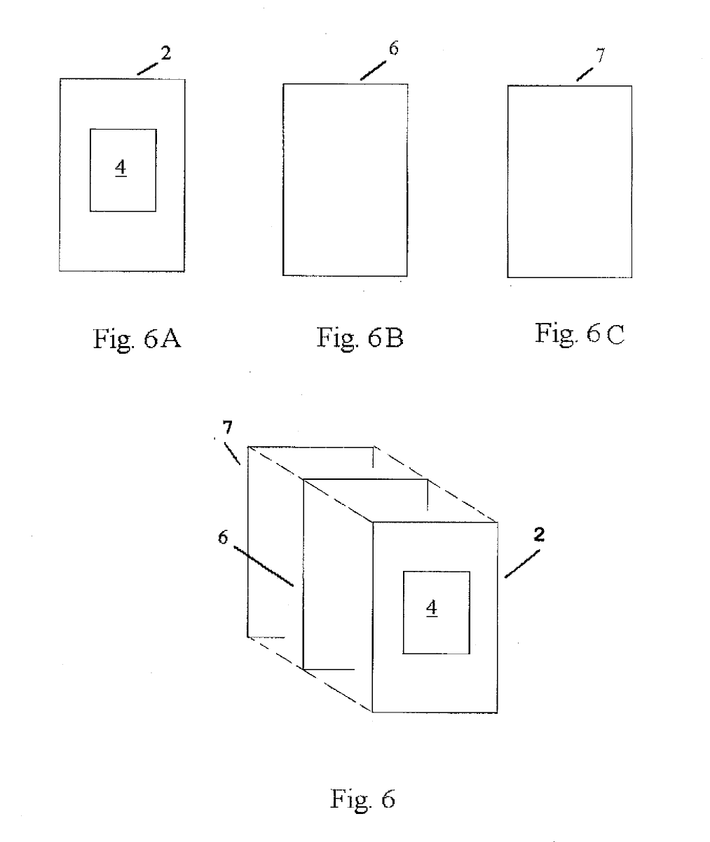

A still further embodiment of the cleaning cloth may be understood by referring now to FIGS. 6, 6A, 6B, and 6C. These figures show the cloth constructed of three different layers. FIG. 6A shows the second layer 2, which contains the oiled central portion 4, or oil square, similar to the construction of the first embodiment. The first layer 7, appearing in FIG. 6C, is made of a material which absorbs moisture as well as oil. And the third layer 6, as shown in FIG. 6B, is made of an impervious material which prevents the oil in the first layer from contaminating the second layer with oil from the first layer.

In its final construction, the three layers are laminated together into a single cloth, as shown in the exploded drawing of FIG. 6.

In practice, the method of using the three-layer embodiment is somewhat different from that of the first embodiment, in that the user may turn the cloth into a position where the second, absorbent layer is used to wipe an area of the object dry, and then the cloth is turned over to apply the oil to the object.

The three-layer embodiment may be manufactured by affixing the oiled central area portion to the cloth after the three layers have been laminated together. Alternatively, the oil may be applied to the central area after all the laminations have taken place, and the central area portion has already been affixed to the cloth.

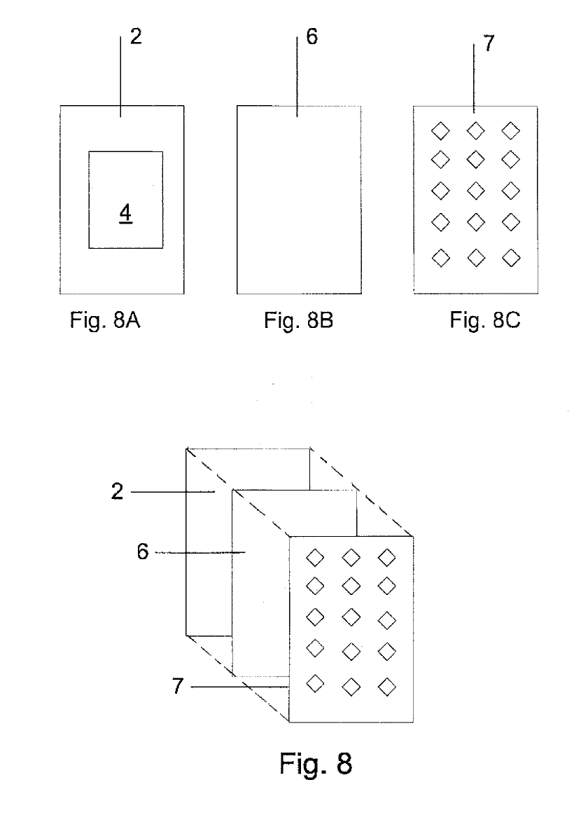

A further embodiment of the cleaning cloth, described in FIGS. 6, 6A, 6B and 6C, may be understood by referring now to FIGS. 8, 8A, 8B, and 8C. FIG. 8A shows the second layer 2 which contains the oiled central portion 4 or oil square 4. FIG. 8B shows the third layer of 6. FIG. 8C shows the first layer 7 with rough surface. FIG. 8 shows a three layer cloth is formed by combine layer 2, layer 6 and layer 7. Layer 6 is affixed between layers 2 and layer 7. Different from FIG. 6C, FIG. 8C shows one of the outer layers contains a rough surface for better contact with the user's hands or the object being treated.

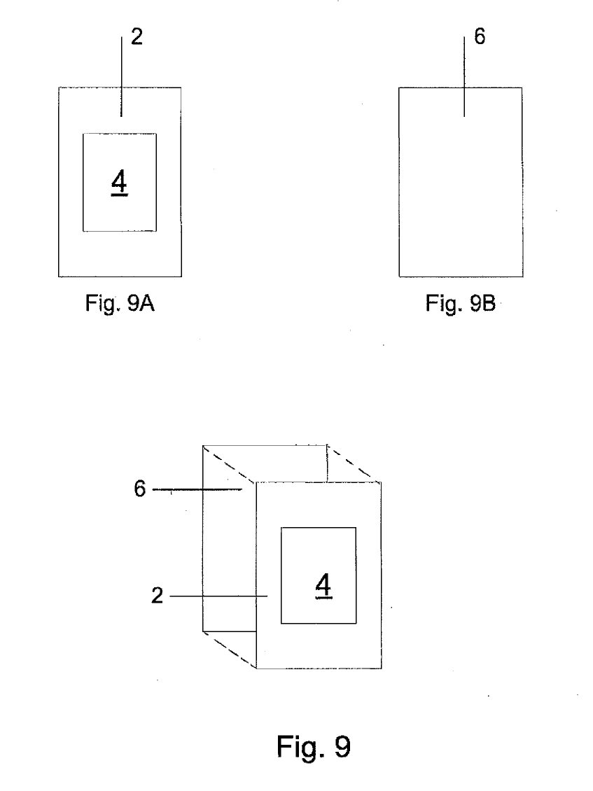

A further embodiment of the cleaning cloth, described in FIGS. 6, 6A, 6B and 6C, may be understood by referring now to FIGS. 9, 9A and 9B. FIG. 9A shows a top layer 2 which contains the oiled central portion 4 or oil square 4. FIG. 9B shows a bottom layer 6 which includes a material that prevents penetration of any oils or aqueous solutions or aqueous suspension in the top layer 2 FIG. 9 shows a two layer cloth is formed by combining layer 2 and layer 6. Different from FIG. 6, FIG. 9 shows a two-layer cloth without layer 7.

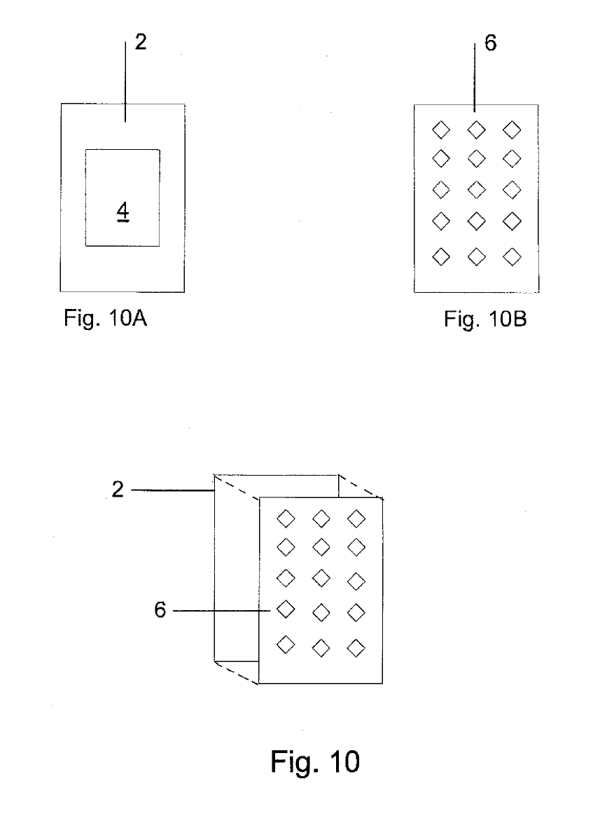

A further embodiment of the cleaning cloth, described in FIGS. 9, 9A and 9B, may be understood by referring now to FIGS. 10, 10A and 10B. FIG. 10A shows the second layer 2 which contains the oiled central portion 4 or oil square 4. FIG. 10B shows the third layer of 6 with a rough surface. FIG. 10 shows a two layer cloth is formed by combining layer 2 and layer 6 with rough surface. Different from FIG. 9B, FIG. 10B shows one of layers of the two-layer cloth contains a rough surface for better contact with the user's hands or the object being treated.

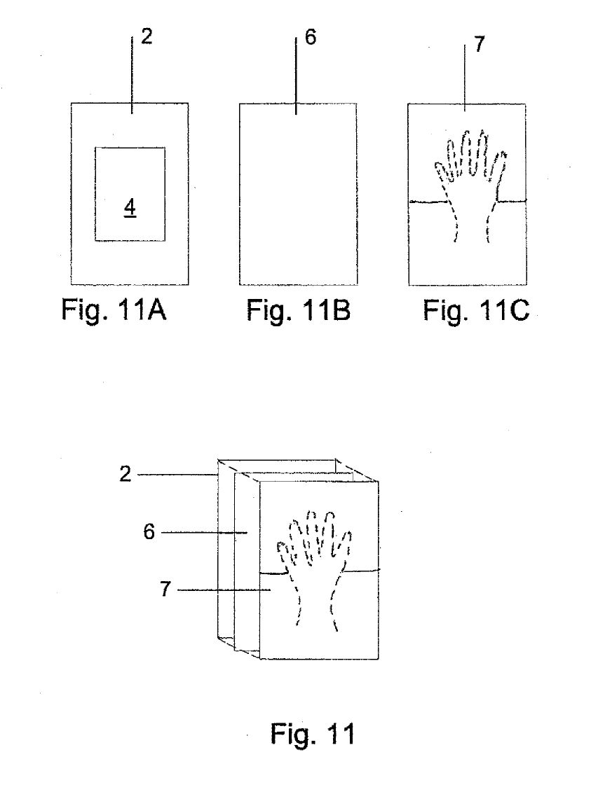

A further embodiment of the cleaning cloth, described in FIGS. 8, 8A, 8B and 8C, may be understood by referring now to FIGS. 11, 11A, 11B, and 11C. FIG. 11A shows the second layer 2 which contains the oiled central portion 4 or oil square 4. FIG. 11B shows the third layer of 6. FIG. 11C shows the first layer 7 with a hand pocket on its outer surface. FIG. 11 shows a three layer cloth is formed by combining layer 2, layer 6 and layer 7 with a hand pocket on the outer surface. Layer 6 is affixed between layers 2 and layer 7. Different from FIG. 8C, FIG. 11C shows one of the outer layers contains a “hand pocket” for easy grabbing by the user.

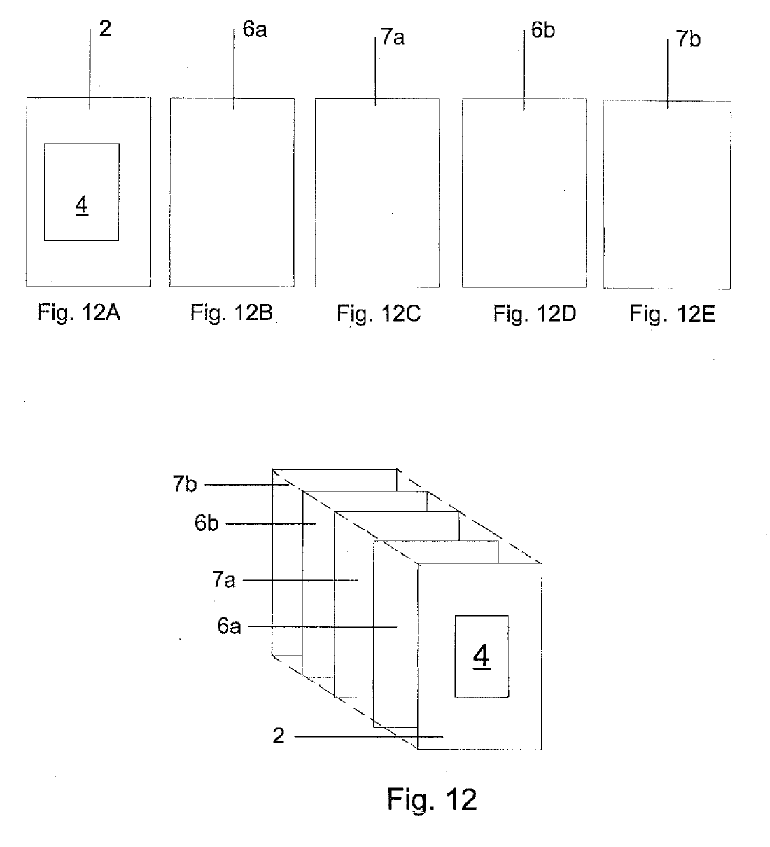

A further embodiment of the cleaning cloth, described in FIGS. 6, 6A, 6B and 6C, may be understood by referring now to FIGS. 12, 12A, 12B, 12C, 12D and 12E. FIG. 12A shows the second layer 2 which contains the oiled central portion 4 or oil square 4. FIG. 12B shows the third layer 6a. FIG. 12C shows the first layer 7a. In addition, FIG. 12D shows another layer of 6b; FIG. 12 E shows another layer of 7b. FIG. 12 shows a five layer cloth is formed by sequential combination of layer 2, layer 6a, layer 7a, layer 6b and layer 7b. One layer 6a is affixed between layers 2 and layer 7a. The other layer 6b is affixed between layer 7a and layer 7b. The difference from FIG. 6 is that, FIG. 12 shows a five-layer cloth formed by the combination of five layers in the order of layer 2, layer 6a, layer 7a, layer 6b and layer 7b.

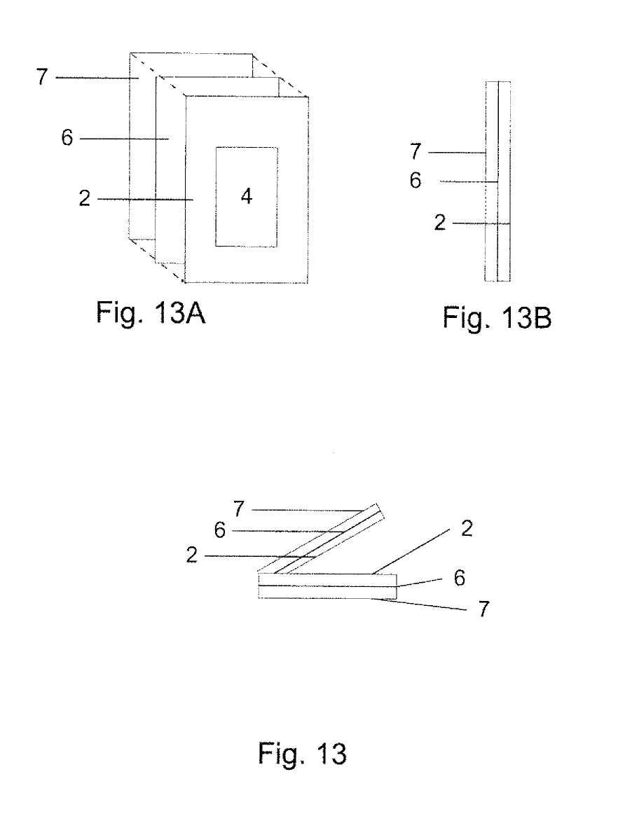

A further embodiment of the cleaning cloth, described in FIGS. 6, 6A, 6B and 6C, may be understood by referring now to FIGS. 13, 13A and 13B. FIG. 13A shows a three layer cloth. FIG. 13B shows the side view of the three layer cloth. FIG. 13 shows the three layer cloth is being folded in the middle; it is being folded the way that layer 2 that contains oil solution, oil suspension, aqueous solution, aqueous suspension and solids is facing inside.

It should also be obvious that the user may wish to use gloves while handling the cloth, to keep the oil further away from the user's skin.

In all of the foregoing descriptions, the word “oil” should be understood to include various types of lubricating substances, including solutions, suspensions, solids and waxes.

This invention has been disclosed in terms of several illustrative embodiments. It will be apparent that many modifications can be made to the disclosed method and apparatus without departing from the invention. Therefore, it is the intent of the appended claims to cover all such variations and modifications as come within the true spirit and scope of this invention.

What is claimed is:

1. A multi-use cleaning and conditioning cloth comprising:
a) a first layer including a material that retains one of a group consisting of an oil solution, oil suspension, aqueous solution, aqueous suspension and solids;
b) a second layer including material that retains one of a group consisting of an oil solution, oil suspension, aqueous solution, aqueous suspension and solids; and
c) a third layer, disposed between said first layer and second layer, including a material that prevents penetration by one of a group consisting of an oil solution, oil suspension, aqueous solution, aqueous suspension and solids; and
said third layer being affixed on one surface to said first layer, and on an opposite surface to said second layer, forming a single cloth.

2. The multi-use cleaning and conditioning cloth as recited in claim 1 wherein a surface of each of said first layer and said second layer comprises cut resistance and structural reinforcement for said cloth.

3. The multi-use cleaning and conditioning cloth as recited in claim 1 wherein said cloth comprises a fold whereby an oil layer or an aqueous layer is located on an inner side of said folded cloth and a non-oil layer or non-aqueous layer is located on outer side of said folded cloth.

4. The multi-use cleaning and conditioning cloth as recited in claim 1 wherein one layer of said first layer and said second layer is combined with said third layer to form a two-layer single cloth, said one layer being made of a material that retains one of a group consisting of oil solution, oil suspension, aqueous solution, aqueous suspension and solids, and another layer being made of said third layer material that prevents penetration of one of a group consisting of oil solution, oil suspension, aqueous solution, aqueous suspension and solids.

5. The multi-use cleaning and conditioning cloth as recited in claim 4 wherein outer surfaces of said two layer single cloth comprise rough surfaces for easy grabbing and scrubbing.

6. The multi-use cleaning and conditioning cloth as recited in claim 4 wherein said two layer single cloth comprises folds whereby an oil layer or an aqueous layer is located on an inner side of said folds of said cloth and a non-oil layer or non-aqueous embedded layer is located on an outer side of said folds of said cloth.

7. The multi-use cleaning and conditioning cloth as recited in claim 1 wherein said cloth comprises additional sequential layers of said third layer having a material that prevents penetration by one of a group consisting of an oil solution, oil suspension, aqueous solution, aqueous suspension and solids followed by another of said second layer including a material that retains one of a group consisting of an oil solution, oil suspension, aqueous solution, aqueous suspension and solids.

8. A method of making a multi-use cleaning and conditioning cloth comprising the steps of:
providing a first layer having a material that retains one of a group consisting of an oil solution, oil suspension, aqueous solution, aqueous suspension and solids;
providing a second layer having a material that retains one of a group consisting of an oil solution, oil suspension, aqueous solution, aqueous suspension and solids;
providing a third layer having a material that prevents penetration by one of a group consisting of an oil solution, oil suspension, aqueous solution, aqueous suspension and solids;
disposing said third layer between said first layer and said second layer; and
affixing said third layer on a surface of said first layer and on an opposite surface of said second layer, forming a single cloth.

9. The method as recited in claim 8 wherein said step of providing a third layer comprises the step of providing said third layer with a material that provides cut resistance and structural reinforcement for said multi-use cloth.

10. The method as recited in claim 8 wherein said method comprises the step of folding said cloth whereby an oil layer or an aqueous layer is located on an inner side of said folded cloth and a non-oil layer or non-aqueous layer is located on an outer side of said folded cloth.

11. A method of using a folded multi-use cleaning and conditioning cloth comprising the steps of:
unfolding said cloth in a way that user's hand only contacts an outer layer of said cloth not having embedded an oil, aqueous solutions, aqueous suspensions, or solids;
holding said outer layers of said cloth;
wiping an inner layer of said cloth on an object thereby applying to said object oil, aqueous solutions and suspensions or solids embedded in said inner layer.

12. The method of use as recited in claim 11 wherein said step of applying said oil comprises the step of applying one of a group consisting of a vegetable oil, natural oil, synthetic oil, semi-synthetic oil and chemical.

13. The method of use as recited in claim 11 wherein said step of applying said aqueous solutions and suspension comprises the step of applying one of a group consisting of water, purified water, natural and synthetic solvents, juices and chemicals.

14. The method of use as recited in claim 11 wherein said step of applying to said object an oil, aqueous solutions, aqueous suspensions, or solids, comprises the step of selecting one from a group consisting of natural and synthetic compounds, powders and wax.

15. The method as recited in claim 1 wherein said step of wiping an inner layer of said cloth on an object comprises the step of cleaning any one of a plurality of metal and non-metal objects including ice skate blades, ski edges, snow board edges, sled runners, knives, fishing rods, guns and golf clubs, human and animal skin, wood, stove, glass, machines, instruments and leather.

16. A multi-use cleaning and conditioning cloth comprising:
a first layer of said cloth includes a material that retains one of a group consisting of an oil solution, oil suspension, aqueous solution, aqueous suspension and solid;
a second layer of material is combined with said first layer to form a two-layer single cloth;
said second layer comprises material that prevents penetration of one of a group consisting of an oil solution, oil suspension, aqueous solution, aqueous suspension and solids.
